(19) United States
(12) Patent Application Publication
(10) Pub. No.: US 2018/0310033 A1
(43) Pub. Date: Oct. 25, 2018

(54) COMPUTER IMPLEMENTED METHOD FOR PROVIDING MULTI-CAMERA LIVE BROADCASTING SERVICE

(71) Applicant: Tellybean Oy, Helsingfors (FI)

(72) Inventors: Patrik JOHNSON, Helsingfors (FI); Cami HONGELL, Helsinki (FI); Mingdong Li, Espoo (FI)

(21) Appl. No.: 15/492,437

(22) Filed: Apr. 20, 2017

(51) Int. Cl. H04N 21/218; H04N 21/2187; H04N 21/258; H04N 21/43; H04N 21/462; H04N 21/472; H04N 21/60

(52) U.S. Cl. CPC H04N 21/21805; H04N 21/2187; H04N 21/25816; H04N 21/60; H04N 21/4622; H04N 21/47202; H04N 21/4307

(57) ABSTRACT

A computer implemented method providing a multi-camera live video capturing and broadcasting service comprising connecting a master device via a local network or a public communication network to at least one wireless slave device using a peer connection; establishing a real time/live session associating the master device and the at least one wireless slave device; capturing real time content of audiovisual (AV) input signals using the at least one wireless slave device and transmitting the real time content to a mixer application of the master device; decoding and mixing the received real time content by the mixer application; encoding the mixed real time content by the mixer application; and broadcasting the encoded real time content by the mixer application to a streaming service of the public communication network.

### TECHNICAL FIELD

The present application generally relates to a method, a device and a system for providing a multi-camera live video capturing and broadcasting service.

### BRIEF DESCRIPTION OF RELATED DEVELOPMENTS

Multimedia connections are widely used as a communication method providing people not only speech but streaming video of the other party as well. High-speed telecommunication networks enable multimedia connection activation and content transmission between terminals.

Communication systems exist which allow a live voice and/or video call to be conducted between two or more end-user terminals over a packet-based network such as the Internet, using a packet-based protocol such as internet protocol (IP). This type of communication is sometimes referred to as “voice over IP” (VoIP) or “video over IP”.

Some of these communication systems work in a browser environment, wherein one user can establish a chat room that others can join. To use most of the communication systems, however, each end user needs first to install a client application onto a memory of his or her user terminal such that the client application is arranged for execution on a processor of that terminal. To establish a call, one user (the caller) indicates a username of at least one other user (the callee) to the client application. When executed the client application can then control its respective terminal to access a database mapping usernames to IP addresses, and thus uses the indicated username to look up the IP address of the callee. The database may be implemented using either a server or a peer-to-peer (P2P) distributed database, or a combination of the two. Once the caller's client has retrieved the callee's IP address, it can then use the IP address to request establishment of a live voice and/or video stream between the caller and callee terminals via the Internet or other such packet-based network, thus establishing a call. An authentication procedure is typically also required, which may involve the user providing credentials via the client to be centrally authenticated by a server, and/or may involve the exchange of authentication certificates between the two or more users' client applications according to a P2P type authentication scheme.

However, such call setup requires always setting up a call between parties and installing software applications to both ends. Still, the multimedia shared is limited to the participants of the call.

With the increasing prevalence of electronic devices capable of capturing real time AV signals and executing communication software, both around the home and in portable devices on the move, then it is possible that multiple different terminals may be available for providing real-time AV content of the same topic, for example.

Furthermore, TV screens are great for consuming different types of audiovisual media, either using the capabilities of the TV itself or the capabilities of a connected set-top box. However, most TVs and set-top boxes are not designed for or even technically capable of allowing users to generate and send their own audiovisual content at sufficiently good quality. This has meant that for example video calling using a TV has not become a widely spread service. This is mainly due to inadequate video encoding capabilities and lack of webcam support.

For a user to generate audiovisual content and to use it as a component of a service consumed on the TV, and send it to a peer user, at least two things are required: I) capturing audio and video content and II) encoding the captured content. For example, live audio and video input from a user may be used as a central component of a service consumed on the big screen of a TV. Examples of such services include video calling and incorporating live video of a user as part of a broadcast of the user playing a game.

Up until recently, in most use cases, such as Skype on TV, both the capturing of the content and encoding it has been done on a webcam device connected to the TV. The problem with this approach has been that the required camera has been expensive, often 100-150$ and the solution has required a lot of specific product development to ensure compatibility between the camera and the hardware.

Recently, some manufacturers of set-top boxes and TVs have started to implement standardized camera support (UVC—Universal Video Class), meaning that in principle any USB-webcam should be compatible. The benefit of this development has been that the cameras are no longer hardware specific, but generic.

However, this is only a start to solving the problem and a few problems remain: I) first, only a small minority of new devices that come out to market have UVC-camera support, II) second, even if the device has UVC-camera support, the user often does not have a USB camera, and III) third, even if there is camera support and a compatible camera, the video encoding capabilities of the TV or the set-top box typically limit the quality of the encoded content.

Furthermore, collaboration of a plurality of wireless terminals to capture live video simultaneously to provide live broadcasting session in a simple and effective way does not exist.

Thus, an easy to set-up, easy to use, low maintenance, low-cost and highly functional solution is needed to allow a user to capture real time content of audiovisual (AV) input signals using at least one wireless slave device and transmit the real time content to a master device for collaboration of a live real time broadcasting session. Furthermore, a solution is needed to improve collaboration between a user device and an AV device.

### SUMMARY

According to a first example aspect of the disclosed embodiments there is provided a computer implemented method providing a multi-camera live video capturing and broadcasting service comprising:

connecting a master device via a local network or a public communication network to at least one wireless slave device using a peer connection;

establishing a real time session associating the master device and the at least one wireless slave device;

capturing real time content of audiovisual (AV) input signals using the at least one wireless slave device and transmitting the real time content to a mixer application of the master device;

decoding and mixing the received real time content by the mixer application;

encoding the mixed real time content by the mixer application; and

broadcasting the encoded real time content by the mixer application to a website or a streaming service of the public communication network.

In an embodiment, the peer connection is one-way peer connection.

In an embodiment, the real time session comprises a WebRTC session.

In an embodiment, the method further comprises:

capturing real time content of audiovisual (AV) input signals, including text, using the master device and transmitting the real time content to the at least one wireless slave device over the peer connection.

In an embodiment, the website or the streaming service is defined by a Uniform Resource Locator (URL) and the master device broadcasts the encoded real time content directly to the public communication network.

In an embodiment, the real time content is streamed to a one-time URL or the streaming service comprises a live video service, such as: Facebook Live™, YouTube™ or Periscope™.

In an embodiment, the method further comprises:

receiving user credentials and logging in a user of the master device automatically to the streaming service.

In an embodiment, establishing the real time session associating the master device and the at least one wireless slave device comprises sending an invitation message from the master device to the at least one wireless slave device for joining the real time session.

In an embodiment, the real time session comprises a WebRTC room.

In an embodiment, the method further comprises:

determining contact information of at least one other user based on contact database stored within the master device and sending the invitation message from the master device to the at least one wireless slave device using the contact information.

In an embodiment, the real time content from the at least one wireless slave device to the mixer application of the master device is transmitted over the peer connection and the established real time session.

In an embodiment, the method further comprises:

connecting the master device via a local network or a public communication network to a plurality of wireless slave devices using a peer connection for each wireless slave device;

establishing a real time session associating the master device and the plurality of wireless slave devices;

capturing real time content of audiovisual (AV) input signals using at least two of the plurality of wireless slave devices and transmitting the real time contents to the mixer application of the master device;

decoding the received real time contents by the mixer application to generate mixed real time contents;

receiving selection information identifying one real time content of the mixed real time contents;

encoding the identified real time content by the mixer application based on the selection information; and

broadcasting the encoded real time content by the mixer application to the website or the streaming service of the public communication network.

In an embodiment, the method further comprises:

providing mixed real time contents from the at least two of the plurality of wireless slave devices by the mixer application on a user interface of the master device;

detecting user interaction via the user interface to generate the selection information identifying one real time content of the mixed real time contents;

encoding the identified real time content by the mixer application based on the selection information; and

broadcasting the encoded real time content by the mixer application to the website or the streaming service of the public communication network.

In an embodiment, the method further comprises:

detecting further user interaction via the user interface to update the selection information identifying one further real time content of the mixed real time contents;

encoding the identified further real time content by the mixer application based on the selection information; and

broadcasting the further encoded real time content by the mixer application to the website or the streaming service of the public communication network replacing the earlier broadcasted encoded real time content.

In an embodiment, the method further comprises:

detecting further user interaction via the user interface to update the selection information identifying one further real time content of the mixed real time contents;

encoding the identified further real time content by the mixer application based on the selection information; and

broadcasting the further encoded real time content by the mixer application to a further website or a further streaming service of the public communication network, wherein the further website or streaming service being different to the website or the streaming service of earlier broadcasted real time content.

In an embodiment, the mixer application is configured to switch between a multi-terminal state of operation in which the mixer application uses the real time contents received from the plurality of wireless slave devices and a same-terminal state of operation in which the mixer application uses real time content generated by the master device only.

In an embodiment, the method further comprises:

connecting the master device via a public communication network or a local connection to a peer device via a peer connection and via a local connection or the public communication network to a local AV device associated with the master device;

establishing a real time session associating the master device and the local AV device using a Uniform Resource Locator (URL) of a browser of the local AV device;

receiving audiovisual (AV) input signals by capturing using the master device, by receiving in real-time from a second device over P2P connection, by simultaneously receiving from the Internet, or by locally retrieving from storage of the master device;

encoding at least a part of the received audiovisual (AV) input signals by the master device to provide encoded audiovisual (AV) input signals;

transmitting the encoded audiovisual (AV) input signals from the master device to the peer device, wherein the encoded audiovisual (AV) input signals are decoded by the peer device; and

receiving encoded audiovisual (AV) input signals from the peer device within the real time session at the local AV device, wherein the audiovisual (AV) input signals from the peer device are decoded and provided using the browser of the local AV device.

In an embodiment, the peer connection comprises a peer-to-peer (P2P) connection.

According to a second example aspect of the disclosed embodiments there is provided a master device for providing a multi-camera live video capturing and broadcasting service comprising:

a communication interface for communicating with a website or a streaming service, and at least one wireless slave device;

a user interface;

at least one processor; and

at least one memory including computer program code;

the at least one memory and the computer program code configured to, with the at least one processor, cause the master device to:
connect the master device via a local network or a public communication network to the at least one wireless slave device using a peer connection;
establish a real time session associating the master device and the at least one wireless slave device;
receive, by a mixer application of the master device, real time content of audiovisual (AV) input signals captured using the at wireless least one wireless slave device;
decode and mix the received real time content by the mixer application;
encode the mixed real time content by the mixer application; and
broadcast the encoded real time content by the mixer application to the website or the streaming service of the public communication network.

In an embodiment, the master device further comprises:

a camera and/or a microphone for capturing real time content; wherein
the at least one memory and the computer program code are further configured to, with the at least one processor, cause the master device to:
   switch the mixer application between a multi-terminal state of operation in which the mixer application uses the real time contents received from the plurality of wireless slave devices and a same-terminal state of operation in which the mixer application uses real time content generated by the master device camera and/or microphone only.

In an embodiment, the at least one memory and the computer program code are further configured to, with the at least one processor, cause the master device to:

receive trigger information via the user interface;

generate a real time session with a plurality of wireless devices in response to the trigger information; and

transmit technical identification information of the real time session to at least one wireless slave device of the plurality of devices.

In an embodiment, the at least one memory and the computer program code are further configured to, with the at least one processor, cause the master device to:

receive the real time content of audiovisual (AV) input signals from the real time session, such as a WebRTC room, without sending any content back.

In an embodiment, the at least one memory and the computer program code are further configured to, with the at least one processor, cause the master device to:

receive share information via the user interface;

generate the technical identification information of the real time session, such as a WebRTC room, in response to the share information; and

transmit the technical identification information to at least one user device via a messaging service application.

According to a third example aspect of the disclosed embodiments there is provided a computer program embodied on a computer readable non-transitory medium comprising computer executable program code, which when executed by at least one processor of a master device, causes the master device to:

connect the master device via a local network or a public communication network to the at least one wireless slave device using a peer connection;

establish a real time session associating the master device and the at least one wireless slave device;

receive, by a mixer application of the master device, real time content of audiovisual (AV) input signals captured using the at least one wireless slave device;

decode and mix the received real time content by the mixer application;

encode the mixed real time content by the mixer application; and

broadcast the encoded real time content by the mixer application to a website or a streaming service of the public communication network.

According to a fourth example aspect of the disclosed embodiments there is provided a wireless slave device.

In an embodiment, the wireless slave device for providing a multi-camera live video capturing and broadcasting service comprises:

a camera and/or a microphone for capturing real time content of audiovisual (AV) input signals;

a communication interface for communicating with a master device;

at least one processor; and

at least one memory including computer program code;

the at least one memory and the computer program code configured to, with the at least one processor, cause the wireless slave device to:
connect the wireless slave device via a local network or a public communication network to the master device using a peer connection;
establish a real time session associating the master device and the wireless slave device;
capture the real time content of audiovisual (AV) input signals; and
transmit the real time content to a mixer application of the master device, wherein the received real time content is decoded and mixed by the mixer application, the mixed real time content is encoded by the mixer application; and the encoded real time content is broadcasted by the mixer application to the website or the streaming service of the public communication network.

According to a fifth example aspect of the disclosed embodiments there is provided a system comprising a master device, a wireless slave device and a public communication network. In an embodiment the system may further comprise a wireless second device.

According to a sixth example aspect of the disclosed embodiments there is provided a peer device. The peer device may be wireless or wired.

According to a seventh example aspect of the disclosed embodiments there is provided a wireless second device.

Different non-binding example aspects and embodiments of the disclosure have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The aspects of the disclosed embodiments will be described, by way of example only, with reference to the accompanying drawings, in which:

FIG. 1a shows a schematic picture of a system according to an aspect of the disclosed embodiments;

FIG. 1b shows another schematic picture of a system according to an aspect of the disclosed embodiments;

FIG. 2 presents an example block diagram of a master device, a peer device or a wireless slave device;

FIG. 3 presents an example block diagram of an AV device;

FIG. 4 presents an example block diagram of a system server apparatus;

FIG. 5 shows a flow diagram showing operations in accordance with an example embodiment relating to the multi-camera live video capturing and broadcasting; and

FIG. 6 shows a flow diagram showing operations in accordance with an aspect of the disclosed embodiments.

### DETAILED DESCRIPTION

In the following description, like numbers denote like elements.

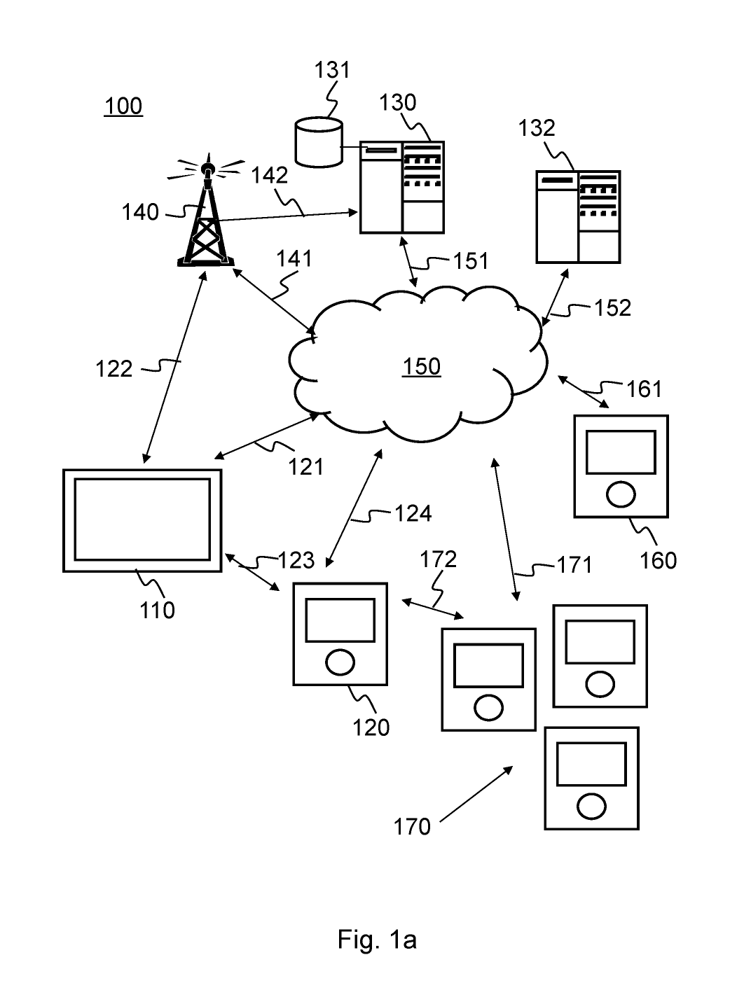

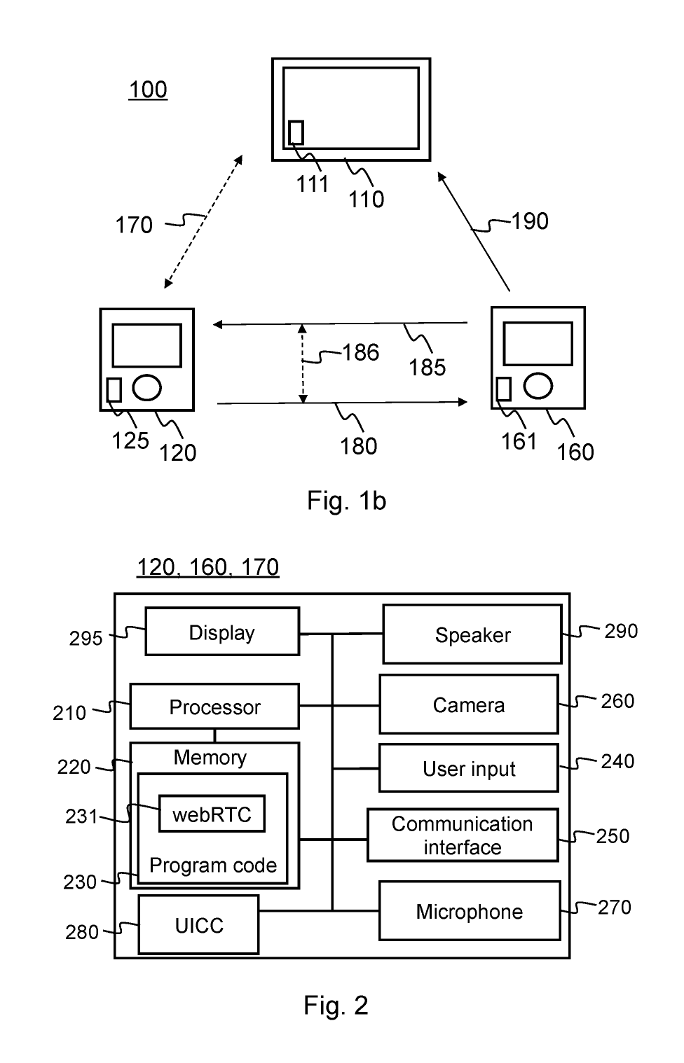

FIG. 1a shows a schematic picture of a system 100 according to an example embodiment. A master device 120 may comprise a mobile terminal comprising a communication interface, for example. The master device 120 is capable of downloading and locally executing software program code. The software program code may be a client application of a service whose peer application is running on a peer device 160, a slave application is running on a wireless slave device(s) 170 and a possible server application is running on a server apparatus 130, 132 of the system 100. The master device 120 or any of the wireless slave devices 170 may comprise a camera and/or microphone for providing real time AV signals. The camera may also be used to provide video stream for a multimedia connection and a microphone may be used for providing audio stream for the multimedia connection, for example. The master device 120 is configured to be connectable to a public network 150, such as Internet, directly via local connection 124 or via a wireless communication network 140 over a wireless connection (not shown). The wireless connection may comprise a mobile cellular network or a wireless local area network (WLAN), for example. The wireless communication network may be to a public data communication network 150, for example the Internet, over a data connection 141. The master device 120 is configured to be connectable to the public data communication network 150, for example the Internet, directly over a data connection 124 that may comprise a fixed or wireless mobile broadband access.

In an embodiment, a master device 120 may be used for providing a multi-camera live video capturing and broadcasting service and the master device 120 comprises a communication interface for communicating with a website or a streaming service and at least one wireless slave device 170; a user interface; at least one processor; and at least one memory including computer program code; the at least one memory and the computer program code are configured to, with the at least one processor, cause the master device 120 to connect the master device 120 via a local network 140,172 or a public communication network 150 to the at least one wireless slave device 170 using a peer connection, such as a one-way peer to peer (P2P) connection; establish a real time session, such as a WebRTC session associating the master device 120 and the at least one wireless slave device 170; receive, by a mixer application of the master device 120, real time content of audiovisual (AV) input signals captured using the at least one wireless slave device 170; decode and mix the received real time content by the mixer application; encode the mixed real time content by the mixer application; and broadcast the encoded real time content by the mixer application to the website or the streaming service of the public communication network 150.

In an embodiment, a master device 120 (mobile phone, tablet or computer) invites a number of wireless slave devices 170 (mobile phone, tablet or computer) to collaborate in a live video capturing and broadcasting session.

The master device 120 comprises a client application and the wireless slave devices 170 may just accept an invite (sent via a communication link locally or remotely over network 150) to join a WebRTC room, for example.

The master device 120 user client application may allow the master device 120 to log into a streaming service run on a server 130,132 for example. The master device 120 may send invitation for collaboration to contacts maintained within the master device 120.

Then again, each of the wireless slave devices 170 may capture and send a live AV stream video to the master device 120 over a peer-to-peer connection formed over a WiFi, mobile or other network, for example.

In an embodiment, one-way WebRTC connection from each of the wireless slave devices 170 to the master device 120 may be utilized and the master device 120 may then decode each stream.

The master device 120 user may control which stream (or streams) received from the wireless slave devices 170 is broadcasted from the master device 120 onwards. The user of the master device 120 may choose one of the streams that the master device 120 encodes and relays as the outgoing stream.

The master device 120 broadcasts the chosen AV stream directly to the Internet 150, for example to a live video service (e.g. Facebook Live, YouTube, or Periscope, run on any of the servers 130,132 for example.

The master device 120 may need to be logged in with user credentials of the master device 120 to the chosen service of the network server 130,132.

AV streams are sent via a peer-to-peer connection from the wireless slave device(s) 170 to the master device 120 (not via cloud server) over mobile network 140 or WiFi 172 and broadcast directly from master device 120 onwards.

The master device 120 may show all incoming real time AV streams on device 120 screen and master device 120 user may choose any available stream by e.g. clicking on it and therefrom streaming to a service enabled first.

In an embodiment, the system 100 comprises an AV device 110 configured to be connectable to the master device 120 over a local connection 123. The local connection 123 may comprise a wired connection or a wireless connection. The wired connection may comprise Universal Serial Bus (USB), High-Definition Multimedia Interface (HDMI), SCART interface or RCA interface, for example. The wireless connection may comprise Bluetooth™, Radio Frequency Identification (RF-ID) or wireless local area network (WLAN), for example. Near field communication (NFC) may be used for device identification between the AV device 110 and the master device 120, for example. The AV device 110 may comprise a television, for example. The AV device 110 may be connected directly to the public network 150, such as Internet, via direct local connection 121 or via a wireless cellular network connection 122, 140, 141.

In an embodiment, the master device 120 is a multimedia connection input device providing encoding of AV input data but using an external display apparatus, such as an AV device 110 for presenting multimedia connection related information to the user.

In an embodiment, the system 100 may comprise a server apparatus 130, which comprises a storage device 131 for storing service data, service metrics and subscriber information, over data connection 151. The service data may comprise configuration data, account creation data, broadcast data, peer-to-peer service data over cellular network and peer-to-peer service data over wireless local area network (WLAN), for example. The service metrics may comprise operator information for use in both user identification and preventing service abuse, as the device 120 and the user account are locked to a subscriber of an operator network using the subscriber identity module (SIM) of the device 120 and the service account details.

In an embodiment, a proprietary application in the master device 120 may be a master client application of a service whose slave client application is running in the wireless slave device 170, peer application is running in a peer device 160 and server application is running on the server apparatus 130 of the system 100.

For a master device 120, the master client application may comprise a simple webapp/website (or Android Native app, for example) configured to provide following functionalities.

In an embodiment, a “Start” button may be provided by the master application on the UI and configured to create a WebRTC room capable of handling up to e.g. 4 participants in response to user of the master device 120 triggering the button.

In an embodiment, an “Invite” button may be provided by the master application to allow the user of the master device 120 to share the WebRTC room URL over appropriate channel (e.g. WhatsApp message or similar) to chosen contacts. The chosen contacts may be fetched from a contact database of the master device 120, for example.

In an embodiment, the master device 120 only receives from the WebRTC room and does not send anything there. After the invited friends operating the wireless slave devices 170 start streaming up AV streams to the room, the master device 120 master application, such as a mixer application, starts to show all incoming AV streams on screen of the master device 120, for example one AV stream in a quadrant of the screen (if e.g. 4 AV streams are incoming).

Then, selecting (e.g. clicking) any one of the displayed AV streams highlights that particular stream and makes it the stream that is relayed to the Internet 150 from the master device 120.

In an embodiment, a “Tell your friends about your broadcast” button may be configured to the master application UI to create a URL to which the broadcast is streamed and which can be shared by another application, such as WhatsApp or such.

In an embodiment, a “Broadcast” button may be configured to the master application UI that allows the user of the master device 120 to start broadcasting the chosen AV stream. The master device 120 user can at any time during the broadcast switch the broadcasted stream to one of the other incoming AV streams from the wireless slave devices 170.

For a wireless slave device 170, the slave client application may comprise a simple webapp/website (or Android Native app, for example) configured to provide following functionalities.

In an embodiment, by selecting (e.g. clicking) on a received WebRTC room invite on the wireless slave device 170 UI opens a WebRTC connection to the WebRTC room.

In an embodiment, the wireless slave device 170 only transmits to the room and does not receive anything from it. The screen on the wireless slave device 170 may display the outgoing AV stream. The wireless slave device 170 may further be configured to zoom in our out to adjust the outgoing AV stream.

For any Internet device 160, the client application may comprise a simple webapp configured to show the broadcast stream and anyone with the URL can join to watch the broadcast.

In an embodiment, the master device 120 may comprise a smartphone, a tablet, a PDA or a computer, for example.

In an embodiment, broadcasted audio signal of the AV stream may be the same as the audio signal of the chosen video stream.

In an embodiment, audio signal may be decoupled from the video signal and it is allowed to use external audio signal from any of the wireless slave devices 170 or the master device 120, for example.

In one use case, a relayed stream can be streamed to any URL, such as Facebook Live or similar or for example a one-time relevant URL (such as “www.livecami20170420.com” or something similar) that is generated specifically and used only for this specific streaming session.

In another use case, free text or pre-defined chat possibility is arranged from master device to wireless slave devices or between all parties. Thus, while the master device is receiving AV content from wireless slave devices, the master device can send text commands to the wireless slave devices (for example: “move further away from loud machine” or “move closer to the speaker”) that the wireless slave device user can read without it affecting the captured AV stream. Some messages may be detected automatically by the wireless slave device and adjust some functionality of the wireless slave device accordingly (for example: “zoom closer” or “auto-focus”).

In an embodiment, a computer implemented method provides a multi-camera live video capturing and broadcasting service comprising connecting a master device 120 via a local network 140,172 or a public communication network 150 to at least one wireless slave device 170 using a peer connection, such as a one-way peer to peer (P2P) connection. Method further comprises establishing a real time session, such as a WebRTC session, associating the master device 120 and the at least one wireless slave device 170 and capturing real time content of audiovisual (AV) input signals using the at least one wireless slave device 170 and transmitting the real time content to a mixer application of the master device 120. Method further comprises decoding and mixing the received real time content by the mixer application and encoding the mixed real time content by the mixer application. Eventually the method comprises broadcasting the encoded real time content by the mixer application to a website or a streaming service of the public communication network 150.

In an embodiment, real time content of audiovisual (AV) input signals, including text, is captured using the master device 120 and transmitting the real time content to the at least one wireless slave device 170.

The streaming service may be defined by a Uniform Resource Locator (URL) and the master device 120 broadcasts the encoded real time content directly to the public communication network 150.

The streaming service comprises a live video service of at least one of the following: Facebook Live™, YouTube™ and Periscope™.

In and embodiment, user credentials may be received and a user of the master device 120 logged in automatically to the streaming service.

The method may further comprise step of establishing the real time WebRTC session associating the master device 120 and the at least one wireless slave device 170 to comprise sending an invitation message from the master device 120 to the at least one wireless slave device 170 for joining a WebRTC room.

Contact information of at least one other user may be determined based on contact database stored within the master device 120 and sending the invitation message from the master device 120 to the at least one wireless slave device 170 using the contact information.

The real time content from the at least one wireless slave device 170 to the mixer application of the master device 120 is transmitted over the one-way peer to peer (P2P) connection and the established real time WebRTC session.

The method may further comprise connecting the master device 120 via a local network 140,172 or a public communication network 150 to a plurality of wireless slave devices 170 using a one-way peer to peer (P2P) connection for each wireless slave device 170, establishing a real time WebRTC session associating the master device 120 and the plurality of wireless slave devices 170, capturing real time content of audiovisual (AV) input signals using at least two of the plurality of wireless slave devices 170 and transmitting the real time contents to the mixer application of the master device 120. Furthermore, the method may comprise decoding the received real time contents by the mixer application to generate mixed real time contents, receiving selection information identifying one real time content of the mixed real time contents, encoding the identified real time content by the mixer application based on the selection information, and broadcasting the encoded real time content by the mixer application to the streaming service of the public communication network 150.

Mixed real time contents from the at least two of the plurality of wireless slave devices 170 may be provided by the mixer application on a user interface of the master device 120, user interaction may be detected via the user interface to generate the selection information identifying one real time content of the mixed real time contents, the identified real time content may be encoded by the mixer application based on the selection information, and the encoded real time content may be broadcasted by the mixer application to the streaming service of the public communication network 150.

Further user interaction may be detected via the user interface of the master device 120 to update the selection information identifying one further real time content of the mixed real time contents, the identified further real time content may be encoded by the mixer application based on the selection information, and the further encoded real time content may be broadcasted by the mixer application to the streaming service of the public communication network 150 replacing the earlier broadcasted the encoded real time content.

In an embodiment, further user interaction may be detected via the user interface of the master device 120 to update the selection information identifying one further real time content of the mixed real time contents, the identified further real time content may be encoded by the mixer application based on the selection information, and the further encoded real time content may be broadcasted by the mixer application to a further streaming service of the public communication network 150, wherein the further streaming service being different to the streaming service of earlier broadcasted real time content.

The mixer application is configured to switch between a multi-terminal state of operation in which the mixer application uses the real time contents received from the plurality of wireless slave devices 170 and a same-terminal state of operation in which the mixer application uses real time content generated by the master device 120 only.

In an embodiment, even without any wireless slave devices 170, and without mixing and broadcasting steps taking place, a method is provided to comprise connecting the master device 120 via a public communication network 150 to a peer device 160 via a peer to peer (P2P) connection and via a local connection 123 or the public communication network 150 to a local AV device 110 associated with the master device 120. The method further comprises establishing a real time WebRTC session associating the master device 120 and the local AV device 110 using a Uniform Resource Locator (URL) of a browser of the local AV device 110, receiving audiovisual (AV) input signals by capturing using the master device 120, by receiving in real-time from a wireless slave 170 or peer device 160 over P2P connection, by simultaneously receiving from the internet 150, or by locally retrieving from storage of the master device 120, encoding at least a part of the received audiovisual (AV) input signals by the master device 120 to provide encoded audiovisual (AV) input signals; transmitting the encoded audiovisual (AV) input signals from the master device 120 to the peer device 160, wherein the encoded audiovisual (AV) input signals are decoded by the peer device 160, and receiving encoded audiovisual (AV) input signals from the peer device 160 within the real time WebRTC session at the local AV device 110, wherein the audiovisual (AV) input signals from the peer device 160 are decoded and provided using the browser of the local AV device 110.

The proprietary application of the master device 120 may capture the user input data for the videophone service and provide the user output data, from the peer 160, for the videophone service using output devices of the master device 120 or using the AV device 110 over the local connection 123. In an embodiment, configuration information or application download information between the master device 120, the peer device 160, the AV device 110 and the system server 130 may be transceived via the first wireless connection 122, 140, 142 automatically and configured by the server apparatus 130. Thus the user of the devices 110, 120, 160 may not need to do any initialization or configuration for the service. The system server 130 may also take care of account creation process for the service, such as videophone service between the master device 120 and the peer 160.

A webRTC browser application may be running in AV device 110, a webRTC peer application may be running in a peer device 160 and web a RTC server application may be running on the server apparatus 130 of the system 100. The proprietary webRTC application of the master device 120 may capture the user input data for the videophone service and provide the user output data, from the peer, for the videophone service using output devices of the master device 120 or using the AV device 110 over the local connection 123. In an embodiment, configuration information or application download information between the master device 120, the peer device 160, the AV device 110 and the system server 130 may be transceived via the first wireless connection 122, 140, 142 automatically and configured by the server apparatus 130. Thus the user of the devices 110, 120, 160 may not need to do any initialization or configuration for the service. The system server 130 may also take care of account creation process for the service, such as videophone service between the master device 120 and the peer 160.

In an embodiment, the system 100 comprises a service provider server apparatus 132, for storing service data, service metrics and subscriber information, over data connection 152. The service data may comprise service account data, peer-to-peer service data and service software, for example. The service provider server apparatus 132 may provide the multimedia connection service for the master device 120 and the peer device 160, whereas the system server 130 is responsible for negotiating account information and client applications for the master device 120 with the service provider server apparatus 132.

In an embodiment, a proprietary application, such as webRTC master application, in the master device 120 may be a client application of a service whose server application is running on the server apparatus 132 of the system 100 and whose peer-to-peer client application is running on the peer-to-peer service apparatus 160. The proprietary application may capture the user input data for the videophone service and provide the user output data, from the peer, for the videophone service using, for example, the AV device 110. Furthermore, the system server apparatus 130 may automatically create a service account in the service server 132, for the master device 120. Thus the user of the master device 120 may not need to do any initialization or configuration for the service. Thus, the system server 130 may take care of account creation process for the service, such as multimedia connection service between the master device 120 and the peer 160.

In an embodiment, the system server apparatus 130 not only configures and creates the account, but may also facilitate pairing of the devices 110, 120 and associating devices 110, 120, 160 to the same multimedia connection.

Both the master device 120 and the AV device 110 need to download a service application, such as webRTC client application (“Master Device App”) and an AV application (“Browser App”), respectively. The applications may be downloaded from the system server 130, for example. Thereafter the master device 120 is paired with the AV device 110 by the user. Pairing may be triggered by entering an identifier (e.g. a number) of the AV device application to the master device application.

After pairing the master device 120 (or the client application/Master Device App, webRTC app) and the AV device 110 (or the AV application/Browser App with webRTC) remain aware of each other and “know” that they are supposed to be part of the same multimedia connection, for example a video call or a game stream. In practice this means that after one of the users of devices 110, 120, 160 dials/starts/initiates a connection or a call with another user, the different devices 110, 120, 160 that are connected to the server 130, are informed and facilitated by the server 130, how the connection should be set up between the different end-points 110, 120, 160. Once the multimedia connection has been set up properly, the AV streams between different devices 110, 120, 160 are opened in the right combination of peer-to-peer connections.

In an embodiment, pairing may comprise pairing of the master device 120 and the AV device 110, pairing of the client application “Master Device App” and the AV application “Browser App” or both.

In an embodiment, the master device 120 and the AV device 110 may be associated using one of many different methods, such as by entering a unique user ID or email address, by entering a unique token (which can be text or e.g. a QR code) or using, for example, some external service, such as Google's Nearby API which is a publish-subscribe API that lets you pass small binary payloads between internet-connected Android and iOS devices. Such devices do not have to be on the same local network, but they do have to be connected to the Internet 150. Nearby uses a combination of e.g. Bluetooth, Bluetooth Low Energy, Wi-Fi and near-ultrasonic audio to communicate a unique-in-time pairing code between devices. The server 130 may facilitate message exchange between devices 110, 120, 160 that detect the same pairing code. When a device detects a pairing code from a nearby device, it sends the pairing code to the Nearby Messages server 130 for validation, and to check whether there are any messages to deliver for the application's current set of subscriptions.

In an embodiment, the association of the devices 110, 120, 160 can be one-time or stored persistently on any of the devices 110, 120, 160 or the server 130, 131.

In an embodiment, for the purposes of a video call, before establishing the AV streams between the different devices all devices participating in the call must be made aware of how they are associated so that each device gets the correct streams.

In an embodiment, the peer connection between the wireless slave device 170 and the master device 120 can be two-way (even though captured AV content only goes from wireless slave to master) because e.g. text commands or other messaging could be going in the other direction from master to slave over that peer connection.

In an embodiment, the real time session may comprise a real time WebRTC session or other similar live session.

In an embodiment, mixed content can be broadcasted to a streaming service or e.g. a one-time generated URL that may correspond to a “WebRTC room”, for example.

In an embodiment, the streaming service may comprises a live video service corresponding to at least one of the following: Facebook Live™, YouTube™ and Periscope™, or any of their future successor.

In an embodiment, a second device may correspond to a slave device.

In an embodiment, technical identification information for a real time session may comprise a URL for WebRTC room.

In an embodiment, a system may comprise a master device 120, at least one wireless slave device 170 and a website or streaming service 130,132. The wireless slave(s) 170 capture AV content and send the AV content to master 120. However, the wireless slave(s) 170 can also send the AV content to the streaming service directly and the master device 120 may send selection information to the streaming service 130,132 to decide which slave output is broadcast at a time. Such approach can be much easier on the master device 120 that may enable better quality or performance.

FIG. 1b shows another schematic picture of a system 100 according to an example embodiment for selected parts of the system 100.

In an embodiment, a user is allowed to use a master device 120, such as a smart phone, a tablet or a computer for both capturing video and audio, as well as encoding at least part of the audiovisual content used as a central part of a multimedia connection service consumed on a screen of an AV device 110, such as a TV screen. Examples of use cases include video calling on the TV and capturing video of a user while he is playing a game for the purposes of broadcasting that game play to other users over the network.

In an embodiment, a first user has an AV application 111 (“TV browser app with webRTC”) installed in the AV device 110 (on a Smart TV or a set-top box or combination of those) and a client application 125 (“Master Device webRTC App”) on a master device 120 (such a phone, tablet or computer) that can pair 170 itself with the “TV browser app with webRTC” 111 to enable association of the devices 110, 120 and to further provide multimedia connection service.

In an embodiment, the master device 120 and the AV device 110 do not have to be connected locally for pairing. The master device 120 and the AV device 110 can be paired also so that the master device 120 is connected to a mobile network over connection 124 and therefrom to the Internet 150 for example, and the AV device 110 is connected over local connection 122 to a local WLAN network 140 and therefrom to the Internet 150, for example.

In an embodiment, a multimedia connection service, for example a video calling service, may be provided, wherein a first user may utilize an AV device 110, such as a smart television, for establishing a multimedia connection with a second user operating a peer device 160. The first user operating the AV device 110 has, for example, a client software AV application 111 (“TV browser app with webRTC”) installed to the AV device 110 and another client software application 125 (“Master Device App with webRTC”) installed to a master device 120. The client software applications 111, 125 between the AV device 110 and the user device 120 are then paired 170. After pairing 170, the “Master Device App with webRTC” 125 of the master device 120 captures audio and video, encodes at least part of them and transmits the at least partially encoded audio and video data 180 to the peer device 160 for the second user. Simultaneously, the AV application 111 (“TV browser app with webRTC”) of the AV device 110 receives and decodes live audio and video 190 sent by the second user operating the peer device 160 for the multimedia connection between the first and the second user. Furthermore, the client application 125 (“Master Device App with webRTC”) receives audio 185 from the peer device 160 in order to be able to manage echo cancellation 186 (i.e. so that the Master Device App does not capture the sound from the AV device 110 and send it back to the second user operating the peer device 160. Thus “circulation” of sound may be prevented or at least minimized. Correspondingly, a client software application 161 (“Peer Device App with webRTC” and/or “TV browser app with webRTC”) may be installed in the peer device 160.

Disclosed embodiments provide multiple advantages. One advantage is that with the solution it is possible to use the camera and the microphone, as well as the hardware encoding capabilities of the master device 120 that the users in most cases already have in the master device 120, such a smart phone or a tablet. Thus the solution is much more accessible and cheaper (the only cost being the cost of the AV application 111 (“TV browser app with webRTC”) and/or the client application 125 (“Master Device App with webRTC”). Another advantage is that usability of the multimedia connection service is improved when the user may use the portable user device for audio and/or video capturing and the TV device 110 for peer audio and/or video output. The master device 120 typically has also better audio and/or video capturing devices than the AV device 110 and encoding features/capabilities that may be used for the multimedia connection.

In an embodiment, authentication of a master device 120 on a system server 130 may utilize hardware or SIM credentials, such as International Mobile Equipment Identity (IMEI) or International Mobile Subscriber Identity (IMSI). The master device 120 may transmit authentication information comprising IMEI and/or IMSI, for example, to the system server 130. The system server 130 authenticates the master device 120 by comparing the received authentication information to authentication information of registered users stored at the system server database 131, for example. Such authentication information may be used for pairing the devices to generate association between them for a multimedia connection.

In an embodiment, a peer-to-peer multimedia connection may be enabled by one of a multitude of client applications 125 that are components of a master device 120 application. Third party account credentials (usernames, passwords, etc.) may be hosted by the system server 130 and utilized when needed for video call setup (calling or answering), for example.

In an embodiment, a service web application may be used for configuration of a system. The service web application may be run on any master device 120 or a remote control apparatus, such as a personal computer connected to a public data network, such as Internet 150, for example. The control apparatus 170 may also be connected locally to the master device 120 over a local connection and utilize the network connections of the master device 120 for configuration purposes. The service web application of the control apparatus may provide searching/adding contacts, personalizing screen name, Wi-Fi Setup and master device 120 configurations, for example. The service web application of the control apparatus may be a general configuration tool for tasks being too complex to be performed on the user interface of the master device 120, such as entering text, for example.

In an embodiment, the remote control apparatus may be authenticated and configuration data sent from the control apparatus to the system server 130, 131 wherein configuration settings for the master device 120 are modified based on the received data. In an embodiment, the modified settings may then be sent to the master device 120 over the network 150 and the local connection or the wireless operator. For example, an SMS-based configuration message may be used to convey the configuration data.

In an embodiment, a method comprises steps of connecting the master device 120 via a public communication network 150 to a peer device 160 via a peer connection and via a local connection or the public communication network to a local AV device 110 associated with the master device 120; establishing a real time session associating the master device and the local AV device using a Uniform Resource Locator (URL) of a browser of the local AV device 110; receiving audiovisual (AV) input signals by capturing using the master device 120, by receiving in real-time from a second device (corresponding to another device 170) over peer connection, by simultaneously receiving from the Internet, or by locally retrieving from storage of the master device 120; encoding at least a part of the received audiovisual (AV) input signals by the master device 120 to provide encoded audiovisual (AV) input signals; transmitting the encoded audiovisual (AV) input signals from the master device 120 to the peer device 160, wherein the encoded audiovisual (AV) input signals are decoded by the peer device 160; and receiving encoded audiovisual (AV) input signals from the peer device 160 within the real time session at the local AV device 110, wherein the audiovisual (AV) input signals from the peer device 160 are decoded and provided using the browser of the local AV device 110.

In an embodiment, the master device 120, the peer device 160 and a second device may be wireless or wired.

FIG. 2 presents an example block diagram of a master device 120, a wireless slave device 170 or a peer device 170, in which various aspects of the disclosed embodiments may be applied. The master device 120, the wireless slave device 170 or the peer device 170 may be a user equipment (UE), user device or apparatus, such as a mobile terminal, a smart phone, a tablet, or other communication device comprising a communication interface, a camera and a microphone.

The general structure of the master device 120 comprises a user input device 240, a communication interface 250, a microphone 270, a camera 260, a processor 210, and a memory 220 coupled to the processor 210. The user device 120 further comprises software 230 stored in the memory 220 and operable to be loaded into and executed in the processor 210. The software 230 may comprise one or more software modules, such as webRTC module 231 that may comprise a mixer application for broadcasting or a videophone application for videocall or both, and can be in the form of a computer program product. The master device 120 may further comprise a universal integrated circuit card (UICC) 280.

In an embodiment, the master device 120 may comprise a display 295 for presenting information to a user of the apparatus 120. In case the apparatus 120 does not comprise the display 295, an external AN apparatus 110 may be used for presenting information. The AV device 110 may be in any case used for the videocall related data.

The processor 210 may be, e.g., a central processing unit (CPU), a microprocessor, a digital signal processor (DSP), a graphics processing unit, or the like. FIG. 2 shows one processor 210, but the master device 120 may comprise a plurality of processors.

The memory 220 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The master device 120 may comprise a plurality of memories. The memory 220 may be constructed as a part of the master device 120 or it may be inserted into a slot, port, or the like of the master device 120 by a user. The memory 220 may serve the sole purpose of storing data, or it may be constructed as a part of an apparatus serving other purposes, such as processing data. Client application data for different services provided by service providers may be stored and run in the memory 220 as well as other master device 120 application data. A client application 125 (“Master Device webRTC App”) is one such software application run by the processor with the memory.

The user input device 240 may comprise circuitry for receiving input from a user of the master device 120, e.g., via a keyboard, a touch-screen of the master device 120, speech recognition circuitry, gesture recognition circuitry or an accessory device, such as a headset or a remote controller, for example.

The camera 260 may be a still image camera or a video stream camera, capable for creating multimedia data for multimedia connection service. The device 120 may comprise several cameras, for example a front camera and a rear camera. The user of the device 120 may select used camera 260 via settings of the device 120 or the client application within the device 120.

In an embodiment, the device 120 may comprise several cameras 260 and/or several user devices 120 each comprising a camera 260 to provide 3D image/video capturing.

Human vision is binocular (stereoscopic): we have two sensors, our two eyes, and because they are horizontally separated we receive two images of the same scene with slightly different viewpoints. The brain superimposes and interprets the images to create a sensation of depth or three-dimensional vision.

In an embodiment, two parallel cameras 260 of a master device 120 are used to simultaneously capture scenes. When the images or video signal are shown at a peer device 160, the image recorded with the left camera is viewed only by the left eye, while the one recorded with the right camera is captured only by the right eye, for example. The reconstruction of images in three dimensions does bring something new because it allows the viewpoint to be freely selected after images have been recorded.

In an embodiment, at least two master devices 120 each comprising a camera 260 may be used for capturing 3D image/video signal. Both master devices 120 may be paired with the associated AV device 110 separately and transmitting encoded audio and video signals to the peer device 160 that receives and compiles the signals to generate 3D image/video signal for the second user. Alternatively a second master device 120 is connected over local connection to a first master device 120 to provide second camera signal and the first master device 120 captures first camera signal and generates from the first and the second camera signal a combined image or video signal with 3D effect. Then only the first master device 120 may be paired with the AV device 110 and the first master device 120 or the AV device 110 transmitting the encoded video signal with 3D effect to the peer device 160.

The speaker 290 is configured to notify a user of an incoming call and to provide other user alarm sounds. Such speaker is advantageous especially in case the A/V output apparatus 110 (e.g. TV) is in off/standby mode. The speaker 290 also allows the user to answer the incoming call and hear the caller before turning the A/V output apparatus 110 (e.g. TV) on. Thus, the user may start the conversation while searching for a remote control of the A/V output apparatus 110 (e.g. TV), for example.

The microphone 270 is configured to capture user speech information for the multimedia connection service.

In an embodiment, the microphone 270 may be used to disable the speaker 290 when identical audio output is detected, using the microphone 270, from an external source, such as the AN output apparatus 110. The device speaker 290 may only be required when the AN output apparatus 110 (e.g. TV) is switched off or operating at very low volumes. The additional audio output from the A/V output apparatus 110 (e.g. TV) is at a variable distance from the microphone 270 (measured in time), compared to the on-board speaker 290 (internal source), which is at a fixed/known distance from the microphone 270. The identical audio output may be detected based on audio data comparison and based on distance calculation the audio data source may be determined to be the AN output apparatus 110 (e.g. TV) and the speaker 290 may be switched off automatically. The universal integrated circuit card (UICC) 280 is the smart card used in mobile terminals in GSM and UMTS networks. The UICC 280 ensures the integrity and security of all kinds of personal data, and it typically holds a few hundred kilobytes. In a GSM network, the UICC 280 contains a SIM application and in a UMTS network the UICC 280 contains a USIM application. The UICC 280 may contain several applications, making it possible for the same smart card to give access to both GSM and UMTS networks, and also provide storage of a phone book and other applications. It is also possible to access a GSM network using a USIM application and it is possible to access UMTS networks using a SIM application with mobile terminals prepared for this.

The communication interface module 250 implements at least part of data transmission. The communication interface module 250 may comprise, e.g., a wireless or a wired interface module. The wireless interface may comprise such as a WLAN, Bluetooth, infrared (IR), radio frequency identification (RF ID), NFC, GSM/GPRS, CDMA, WCDMA, LTE (Long Term Evolution) or 5G radio module. The wired interface may comprise such as universal serial bus (USB), HDMI, SCART or RCA, for example. The communication interface module 250 may be integrated into the master device 120, or into an adapter, card or the like that may be inserted into a suitable slot or port of the master device 120. The communication interface module 250 may support one radio interface technology or a plurality of technologies. The communication interface module 250 may support one wired interface technology or a plurality of technologies. The master device 120 may comprise a plurality of communication interface modules 250.

A skilled person appreciates that in addition to the elements shown in FIG. 2, the master device 120 may comprise other elements, such as additional microphones, extra speakers, extra cameras, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the master device 120 may comprise a disposable or rechargeable battery (not shown) for powering when external power if external power supply is not available.

In an embodiment, the master device 120 comprises speech or gesture recognition means. Using these means, a pre-defined phrase or a gesture may be recognized from the speech or the gesture and translated into control information for the master device 120, for example.

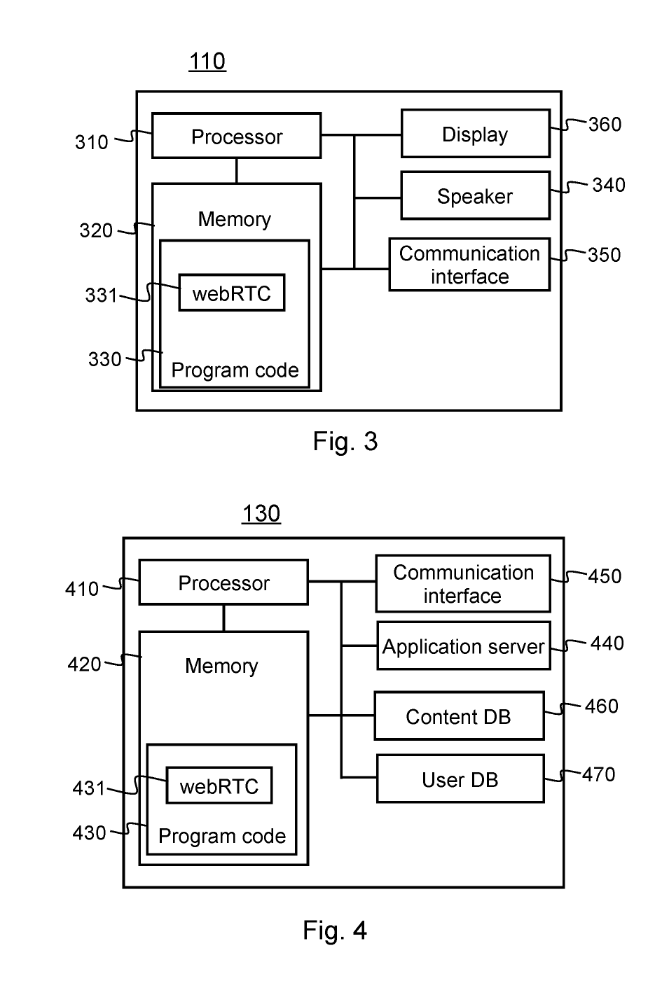

FIG. 3 presents an example block diagram of an AV device 110 in which various aspects of the disclosed embodiments may be applied. The A/V output apparatus 110 may be a television comprising a communication interface, a display and a speaker.

The general structure of the AV device 110 comprises a communication interface 350, a display 360, a processor 310, and a memory 320 coupled to the processor 310. The AV device 110 further comprises software 330 stored in the memory 320 and operable to be loaded into and executed in the processor 310. The software 330 may comprise one or more software modules, such as webRTC module 331 that may comprised by a browser application for videocall service or broadcast service, and can be in the form of a computer program product. An AV application 111 (“webRTC TV App”) is one such software application.

The processor 310 may be, e.g., a central processing unit (CPU), a microprocessor, a digital signal processor (DSP), a graphics processing unit (GPU), or the like. FIG. 3 shows one processor 310, but the AV device 110 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The AV device 110 may comprise a plurality of memories. The memory 320 may be constructed as a part of the A/V output apparatus 110 or it may be inserted into a slot, port, or the like of the A/V output apparatus 110 by a user. The memory 320 may serve the sole purpose of storing data, or it may be constructed as a part of an apparatus serving other purposes, such as processing data.

The speaker 340 may comprise a loudspeaker or multiple loudspeakers with wired or wireless connections. Furthermore, the speaker 340 may comprise a jack for headphones and the headphones.

The display 360 may comprise a LED screen, a LCD screen or a plasma screen, for example.

The communication interface module 350 implements at least part of data transmission. The communication interface module 350 may comprise, e.g., a wireless or a wired interface module. The wireless interface may comprise such as a WLAN, Bluetooth, infrared (IR) or radio frequency identification (RF ID) radio module. The wired interface may comprise such as universal serial bus (USB), HDMI, SCART or RCA, for example. The communication interface module 350 may be integrated into the AV device 110, or into an adapter, card or the like that may be inserted into a suitable slot or port of the AV device 110. The communication interface module 350 may support one radio interface technology or a plurality of technologies. The communication interface module 350 may support one wired interface technology or a plurality of technologies. The AV device 110 may comprise a plurality of communication interface modules 350.

A skilled person appreciates that in addition to the elements shown in FIG. 3, the AV device 110 may comprise other elements, such as microphones, speakers, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the AV device 110 may comprise a disposable or rechargeable battery (not shown) for powering when external power if external power supply is not available.

FIG. 4 presents an example block diagram of a system server apparatus 130 in which various aspects of the disclosed embodiments may be applied.

The general structure of the system server apparatus 130 comprises a processor 410, and a memory 420 coupled to the processor 410. The server apparatus 130 further comprises software 430 stored in the memory 420 and operable to be loaded into and executed in the processor 410. The software 430 may comprise one or more software modules such as webRTC module 431 that may be used for videocall service or broadcast service and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 130 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The system server apparatus 130 may comprise a plurality of memories. The memory 420 may be constructed as a part of the system server apparatus 130 or it may be inserted into a slot, port, or the like of the system server apparatus 130 by a user. The memory 420 may serve the sole purpose of storing data, or it may be constructed as a part of an apparatus serving other purposes, such as processing data.

The communication interface module 450 implements at least part of data transmission. The communication interface module 450 may comprise, e.g., a wireless or a wired interface module. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface module 450 may be integrated into the server apparatus 130, or into an adapter, card or the like that may be inserted into a suitable slot or port of the system server apparatus 130. The communication interface module 450 may support one radio interface technology or a plurality of technologies. Configuration information between the master device 120 and the system server apparatus 130 may be transceived using the communication interface 450. Similarly, account creation information between the system server apparatus 130 and a service provider may be transceived using the communication interface 450.

An application server 440 provides application services e.g. relating to the user accounts stored in a user database 470 and to the service information stored in a service database 460. The service information may comprise content information, content management information or metrics information, for example.

A skilled person appreciates that in addition to the elements shown in FIG. 4, the system server apparatus 130 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

The peer apparatus 160 in which various aspects of the disclosed embodiments may be applied, may be illustrated with similar structure as shown in FIG. 2 for the master device 120. The peer apparatus 160 may be a user equipment (UE), user device or apparatus, such as a mobile terminal, a smart phone, a laptop computer, a desktop computer or other communication device, such as a master device or an AV device. The peer apparatus 160 may comprise a corresponding master device 120 associated with an AV device 110, as in the first end of the connection.

In an embodiment, screen or application data sharing from the master device 120 to the peer device 160 is enabled during the multimedia connection.

In an embodiment, such method comprises selecting, by the first user, at least one of a plurality of applications 230,231 operating in the master device 120 to share with at least the peer device 160, and initiating application sharing in the master device 120 for the selected application 230,231, wherein an image of or data displayed at the display 295 of the master device 120 is transmitted as video input signals from the first user for the display 540 at the peer device 160, and wherein the second user is permitted to access or observe an initiated application 230,231, but is not permitted to perform any unauthorized operations on an application 230,231 being shared.

In an embodiment, the first user provides selection information via user interface 240 of the master device 120, and the selection information is configured to control whether video input signals captured from a camera 260 of the master device 120 or from the shared application 230 is encoded as video input signals from the first user by the master device 120 to provide encoded audio and video input signals.

In an embodiment, the first user provides selection information via user interface 240 of the master device 120, and the selection information is configured to control whether audio input signals captured from a microphone 270 of the master device 120 or from the shared application 230,231 is encoded as audio input signals from the first user by the master device 120 to provide encoded audio and video input signals.

In an embodiment, data shared by a shared application 230,231 of a master device 120 may comprise still pictures, video streams, audio streams of videos or music, for example.

In an embodiment, augmented screen or application data sharing from the master device 120 to the peer device 160 is enabled during the multimedia connection.

In an embodiment, such method comprises selecting, by the first user, at least one of a plurality of applications 230,231 operating in the master device 120 to share with at least the peer device 160, and initiating application sharing in the master device 120 for the selected application 230, wherein at least part of data provided by the shared application 230 is transmitted combined with video input signals from the first user for augmented display information at the peer device 160, and wherein the second user is permitted to access or observe an initiated application 230,231 but is not permitted to perform any unauthorized operations on an application 230,231 being shared.

In an embodiment, the first user provides selection information via user interface 240 of the master device 120, and the selection information is configured to control whether video input signals captured from a camera 260 of the user device only, or as augmented with the data provided by the shared application 230, is encoded as video input signals from the first user by the master device 120 to provide encoded audio and video input signals.

In an embodiment, the method further comprises generating from the video input signals captured from a camera 260 of the master device 120 as a first video stream; and generating from the at least part of the data provided by the shared application 230,231 as a second video stream.

In an embodiment, the method further comprises combining the first and the second video stream to provide the video input signals for encoding.

In an embodiment, the method further comprises encoding the first and the second video stream separately to provide first and second encoded video input, and transmitting the encoded audio and the first and the second video input signals from the master device 120 to the peer device 160, wherein the encoded audio and video input signals are decoded and provided for the second user of the peer device 160.

In an embodiment, the at least partially encoded audio and video data 180 in FIG. 1b may comprise only one video input signal set or a plurality of video signal sets (e.g. augmented data transmitted separately).

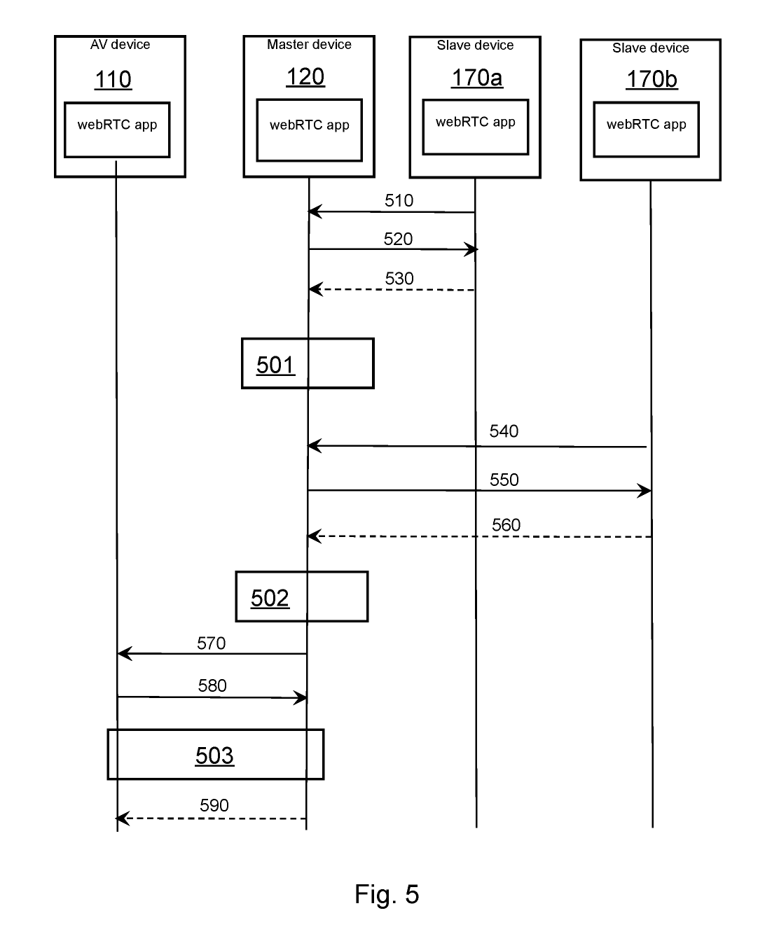

FIG. 5 shows a flow diagram showing operations in accordance with an example embodiment relating to the multi-camera live video capturing and broadcasting.

A computer implemented method providing a multi-camera live video capturing solution and broadcasting service comprises following steps 1-10 illustrated in FIG. 5. Not all steps are mandatory and the order of steps may vary.

Step 1: Signalling message(s) 510, 520 are transceived between a master device 120 and a wireless slave device 170a. The master device 120 may be connected via a local network or a public communication network to at least one wireless slave device 170a, 170b using a peer connection. A real time session associating the master device and the at least one wireless slave device is established. Order of the messages 510, 520 may vary, as well as the amount of messages in either direction.

Step 2: Real time content of audiovisual (AV) input signals is captured using the at least one wireless slave device 170a and the real time content is transmitted to a mixer application of the master device, illustrated as stream 530 in FIG. 5.

Step 3: The received real time content 530 is decoded and mixed by the mixer application (e.g. webRTC app of FIG. 5) of the master device 120 and encoding the mixed real time content by the mixer application.

Step 4: The encoded real time content is broadcasted 501 by the mixer application to a website or a streaming service of the public communication network.

Solid lines correspond to signaling between the master device 120 and the slave device(s) 170a,b when setting up a live AN session.

Step 5: Signalling message(s) 540, 550 are transceived between the master device 120 and a wireless slave device 170b. The master device 120 may be connected via a local network or a public communication network to the at least one wireless slave device 170b using a peer connection. A real time session associating the master device 120 and the at least one wireless slave device 170b is established. Order of the messages 540, 550 may vary, as well as the amount of messages in either direction.

Step 6: Real time content of audiovisual (AV) input signals is captured using the at least one wireless slave device 170b and the real time content is transmitted to the mixer application of the master device 120, illustrated as stream 560 in FIG. 5.

Step 7: The received real time content 560 is decoded and mixed by the mixer application (e.g. webRTC app of FIG. 5) of the master device 120 and encoding the mixed real time content by the mixer application.

Step 8: The encoded real time content is broadcasted 502 by the mixer application to a website or a streaming service of the public communication network. For example, in response to master device 120 control, the broadcasted content may be switched from first content 510 to second content 502. Thus, the master device 120, may use any AN live stream 530, 560 received from any of the wireless slave device(s) 170a,b for encoding and mixing for the broadcast stream 501,502. The encoded real time content is broadcasted and may comprise at least one of the stream(s) from at least one of the slave devices 170a,b.

Step 9: The master device 120 may be connected via a public communication network to a peer device (not shown) via a peer connection and via a local connection or the public communication network to a local AV device 110 associated with the master device 120. Signalling message(s) 570, 580 are transceived between the master device 120 and the local AV device 110 for that. A real time session 503 associating the master device 120 and the local AV device 110 is established using a Uniform Resource Locator (URL) of a browser of the local AV device.

Solid lines 570,580 correspond to signaling between the master device 120 and the AV device 110 when setting up the forwarded or live session from one of the slave device, the second device or the peer device based on a user request of the master device 120 or automatically by the master device 120 based on predefined criteria, for example.

Step 10: Dotted line 590 illustrates that the master device 120 streams live A/V stream to the AV device 110 over the live session 503.

In an embodiment, audiovisual (AV) input signals 590 may be received by capturing using the master device 120, by receiving in real-time from a second device over peer connection, by simultaneously receiving from the Internet, or by locally retrieving from storage of the master device. At least a part of the received audiovisual (AV) input signals may be encoded by the master device 120 to provide encoded audiovisual (AV) input signals 590 and transmit the encoded audiovisual (AV) input signals 590 from the master device 120 to the peer device (not shown), wherein the encoded audiovisual (AV) input signals are decoded by the peer device. Encoded audiovisual (AV) input signals from the peer device may be received within the real time session 503 at the local AV device 110, wherein the audiovisual (AV) input signals from the peer device are decoded and provided using the browser of the local AV device 110.

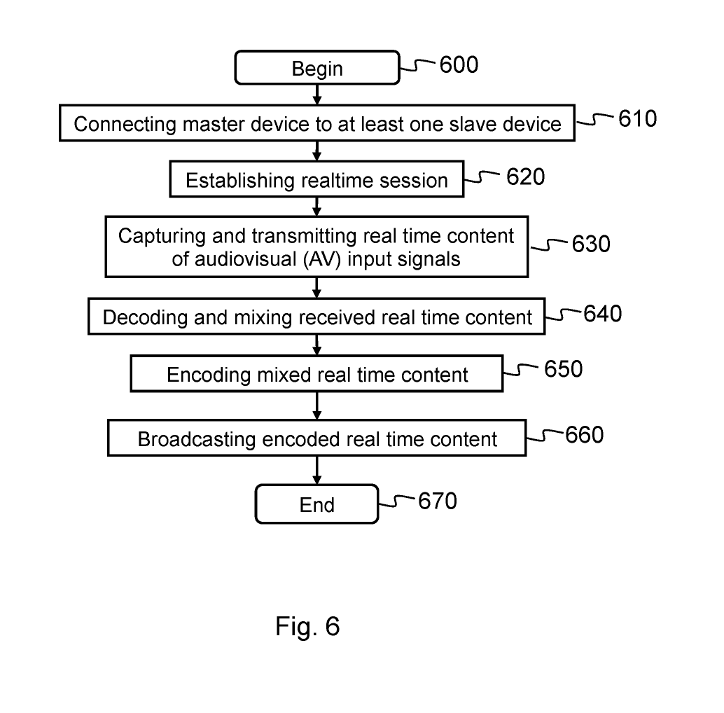

FIG. 6 shows a flow diagram showing operations in accordance with an example embodiment. In step 600, the computer implemented method providing a multi-camera live video capturing and broadcasting service is started. In step 610, a master device is connected via a local network or a public communication network to at least one wireless slave device using a peer connection. In step 620, a real time (e.g. WebRTC) session is established associating the master device and the at least one wireless slave device. In step 630, real time content of audiovisual (AV) input signals is captured using the at least one wireless slave device and transmitting the real time content to a mixer application of the master device. In step 640, the received real time content is decoded and mixed by the mixer application. In step 650, the mixed real time content is encoded by the mixer application. In step 660, the encoded real time content is broadcasted by the mixer application to a website or a streaming service of the public communication network. The method is ended in step 670.

Without in any way limiting the scope, interpretation, or application of the claims appearing below, a technical effect of one or more of the example embodiments disclosed herein is improved live video streaming system. Another technical effect of one or more of the example embodiments disclosed herein is improved multi-camera AV stream broadcasting system. Another technical effect of one or more of the example embodiments disclosed herein is improved mixing of a plurality of AV streams. Another technical effect of one or more of the example embodiments disclosed herein is arranging a videocall service with a peer device using AV device such as a television. Another technical effect of one or more of the example embodiments disclosed herein is the provision of a simplified and reliable system for associating a master device with a plurality of wireless slave devices.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications that may be made without departing from the scope of the present invention as defined in the appended claims.

1. A computer implemented method providing a multi-camera live video capturing and broadcasting service comprising:
connecting a master device via a local network or a public communication network to at least one wireless slave device using a peer connection;
establishing a real time session associating the master device and the at least one wireless slave device;
capturing real time content of audiovisual (AV) input signals using the at least one wireless slave device and transmitting the real time content to a mixer application of the master device;
decoding and mixing the received real time content by the mixer application;
encoding the mixed real time content by the mixer application; and
broadcasting the encoded real time content by the mixer application to a website or a streaming service of the public communication network.

2. The method of claim 1, further comprising:
capturing real time content of audiovisual (AV) input signals, including text, using the master device and transmitting the real time content to the at least one wireless slave device over the peer connection.

3. The method of claim 1, wherein the website or the streaming service is defined by a Uniform Resource Locator (URL) and the master device broadcasts the encoded real time content directly to the public communication network.

4. The method of claim 3, wherein the real time content is streamed to a one-time URL or the streaming service comprises a live video service of: Facebook Live™, YouTube™ and Periscope™.

5. The method of claim 4, further comprising:
receiving user credentials and logging in a user of the master device automatically to the streaming service.

6. The method of claim 1, wherein establishing the real time session associating the master device and the at least one wireless slave device comprises sending an invitation message from the master device to the at least one wireless slave device for joining the real time session.

7. The method of claim 6, further comprising:
determining contact information of at least one other user based on contact database stored within the master device and sending the invitation message from the master device to the at least one wireless slave device using the contact information.

8. The method of claim 6, the real time content from the at least one wireless slave device to the mixer application of the master device is transmitted over the peer connection and the established real time session.

9. The method of claim 1, further comprising:
connecting the master device via a local network or a public communication network to a plurality of wireless slave devices using a peer connection for each wireless slave device;
establishing a real time session associating the master device and the plurality of wireless slave devices;
capturing real time content of audiovisual (AV) input signals using at least two of the plurality of wireless slave devices and transmitting the real time contents to the mixer application of the master device;
decoding the received real time contents by the mixer application to generate mixed real time contents;
receiving selection information identifying one real time content of the mixed real time contents;
encoding the identified real time content by the mixer application based on the selection information; and
broadcasting the encoded real time content by the mixer application to the website or the streaming service of the public communication network.

10. The method of claim 9, further comprising:
providing mixed real time contents from the at least two of the plurality of wireless slave devices by the mixer application on a user interface of the master device;
detecting user interaction via the user interface to generate the selection information identifying one real time content of the mixed real time contents;
encoding the identified real time content by the mixer application based on the selection information; and
broadcasting the encoded real time content by the mixer application to the website or the streaming service of the public communication network.

11. The method of claim 10, further comprising:
detecting further user interaction via the user interface to update the selection information identifying one further real time content of the mixed real time contents;
encoding the identified further real time content by the mixer application based on the selection information; and
broadcasting the further encoded real time content by the mixer application to the website or the streaming service of the public communication network replacing the earlier broadcasted the encoded real time content.

12. The method of claim 10, further comprising:
detecting further user interaction via the user interface to update the selection information identifying one further real time content of the mixed real time contents;
encoding the identified further real time content by the mixer application based on the selection information; and
broadcasting the further encoded real time content by the mixer application to a further website or streaming service of the public communication network, wherein the further streaming service being different to the website or the streaming service of earlier broadcasted real time content.

13. The method of claim 10, wherein the mixer application is configured to switch between a multi-terminal state of operation in which the mixer application uses the real time contents received from the plurality of wireless slave devices and a same-terminal state of operation in which the mixer application uses real time content generated by the master device only.

14. The method of claim 1, further comprising:
connecting the master device via a public communication network to a peer device via a peer connection and via a local connection or the public communication network to a local AV device associated with the master device;
establishing a real time session associating the master device and the local AV device using a Uniform Resource Locator (URL) of a browser of the local AV device;
receiving audiovisual (AV) input signals by capturing using the master device, by receiving in real-time from a second device over peer connection, by simultaneously receiving from the Internet, or by locally retrieving from storage of the master device;
encoding at least a part of the received audiovisual (AV) input signals by the master device to provide encoded audiovisual (AV) input signals;
transmitting the encoded audiovisual (AV) input signals from the master device to the peer device, wherein the encoded audiovisual (AV) input signals are decoded by the peer device; and
receiving encoded audiovisual (AV) input signals from the peer device within the real time session at the local AV device, wherein the audiovisual (AV) input signals from the peer device are decoded and provided using the browser of the local AV device.

15. A master device for providing a multi-camera live video capturing solution and broadcasting service comprising:
a communication interface for communicating with a website or a streaming service, and at least one wireless slave device;
a user interface;
at least one processor; and
at least one memory including computer program code;
the at least one memory and the computer program code configured to, with the at least one processor, cause the master device to:
connect the master device via a local network or a public communication network to the at least one wireless slave device using a peer connection;
establish a real time session associating the master device and the at least one wireless slave device;
receive, by a mixer application of the master device, real time content of audiovisual (AV) input signals captured using the at least one wireless slave device;
decode and mix the received real time content by the mixer application;
encode the mixed real time content by the mixer application; and
broadcast the encoded real time content by the mixer application to the website or the streaming service of the public communication network.

16. The master device of claim 15, further comprising:
a camera and/or microphone for capturing real time content; wherein
the at least one memory and the computer program code are further configured to, with the at least one processor, cause the master device to:
switch the mixer application between a multi-terminal state of operation in which the mixer application uses the real time contents received from the plurality of wireless slave devices and a same-terminal state of operation in which the mixer application uses real time content generated by the master device camera and/or microphone only.

17. The master device of claim 15, wherein the at least one memory and the computer program code are further configured to, with the at least one processor, cause the master device to:
receive trigger information via the user interface;
generate a real time session for a plurality of devices in response to the trigger information; and
transmit technical identification information of the real time session to at least one wireless slave device of the plurality of devices.

18. The master device of claim 17, wherein the at least one memory and the computer program code are further configured to, with the at least one processor, cause the master device to:
receive the real time content of audiovisual (AV) input signals from the real time session without sending any content back.

19. The master device of claim 18, wherein the at least one memory and the computer program code are further configured to, with the at least one processor, cause the master device to:
receive share information via the user interface;
generate the technical identification information of the real time session in response to the share information; and
transmit the technical identification information of the real time session to at least one user device via a messaging service application.

20. A computer program embodied on a computer readable non-transitory medium comprising computer executable program code, which when executed by at least one processor of a master device, causes the master device to:
connect the master device via a local network or a public communication network to the at least one wireless slave device using a peer connection;
establish a real time session associating the master device and the at least one wireless slave device;
receive, by a mixer application of the master device, real time content of audiovisual (AV) input signals captured using the at least one wireless slave device;
decode and mix the received real time content by the mixer application;
encode the mixed real time content by the mixer application; and
broadcast the encoded real time content by the mixer application to the website or the streaming service of the public communication network.
